(19) United States
(12) Patent Application Publication
(10) Pub. No.: US 2002/0129801 A1
(43) Pub. Date: Sep. 19, 2002

(54) Short-stroke valve assembly for modulated pulsewidth flow control

(76) Inventors: Craig D. Smith, Penfield, NY (US); Gary DeAngelis, Spencerport, NY (US); Todd P. Geib, Fairport, NY (US)

Correspondence Address: Delphi Technologies, Inc., P.O. Box 5052, Mail Code 480414420, Troy, MI, 48007, US

(21) Appl. No.: 10/028,131

(22) Filed: Dec. 20, 2001

Related U.S. Application Data
(60) Provisional application No. 60/276,629, filed on Mar. 16, 2001.

(51) Int. Cl. F02M 25/07

(52) U.S. Cl. 123/568.21

(57) ABSTRACT

A short-stroke solenoid-actuated valve suitable for pulsewidth modulated operation including a plurality of components formed of powdered metal, preferably a 400-series stainless steel compressed to about 6.0 g/cm³, to be sound absorptive and ferromagnetic; resilient radial seal means disposed in an annular groove in an outer surface of the valve for sealing against a cylindrical receiving surface; metal mesh shaft seal means for inhibiting leakage from the valve into the actuator; and a dielectric polymeric encapsulant loaded with a thermally conductive particulate substance to increase the heat-transfer modulus of the encapsulant.

### CROSS-REFERENCE TO RELATED APPLICATIONS

This application claims the benefit of US Provisional Application, Serial No. 60/276,629, filed Mar. 16, 2001.

### TECHNICAL FIELD

The present invention is related to solenoid-actuated poppet valves; more particularly, to such poppet valves used to meter the recirculation of exhaust gas (EGR) into the fuel/air intake systems of internal combustion engines; and most particularly, to an EGR valve for modulated pulsewidth flow control wherein the noise output from valve actuation is mechanically damped through improved valve configuration and improved materials, the heat of valve operation is reduced through use of an improved thermally conductive polymeric encapsulant, improved installation seal means is provided to withstand extreme environmental temperatures, and improved pintle shaft seal means inhibits gas leakage into the actuator.

### BACKGROUND OF THE INVENTION

In many automotive vehicles, a variety of “underhood” systems include solenoid operated valves, typically poppet-type valves wherein a pintle-mounted valve head (the poppet) is variably mated with a valve seat separating two chambers to regulate flow of material across the valve seat between the chambers. Systems using such valves include, for example, canister purge systems, vacuum actuators, EGR valves, carburetor mixture systems, and braking systems. In many vehicles currently being manufactured, variable control of these devices is achieved digitally by software in a master engine control module (ECM). Such control is known in the art as “modulated pulsewidth flow control.” In digital control, the valve is stroked between fully closed and fully opened, the duty cycle being varied temporally (modulated pulsewidth) to achieve a desired average flow, rather than by driving the valve head to an intermediate position and holding it there, as in older prior art analog control systems. Thus the length of stroke of the valve is fixed by its construction and is not an operational variable. Further, a very short stroke between fully open and fully closed is highly desirable. For actuation, a valve controlled by modulated pulsewidth typically is provided with a train of pulses at a constant frequency, for example, 10 Hz or 20 Hz, and the pulsewidth of the open phase relative to the closed phase is modulated to achieve the desired flow. This may be changed at the discretion of the calibrator. Digitally-controllable valves typically have very short strokes, on the order of 350 μm, and rely on relatively large-diameter flow passages to achieve flow comparable to that achievable by known long-stroke analog-controlled valves. A short-stroke valve suitable for modification in accordance with the invention is disclosed in U.S. Pat. No. 6,189,519 B1 issued Feb. 20, 2001 to Press et al., the relevant disclosure of which is herein incorporated by reference.

Known short-stroke valves can be subject to numerous shortcomings. They may: be relatively heavy; be adapted for seal mounting on axial surfaces from which they can easily become loosened by thermal expansion during use; have relatively weak, or conversely large, solenoids; leak gas along the pintle shaft into the actuator, and; tend to develop high internal temperatures because of the solenoid's high and constant duty cycle, typically 20 Hz or greater, and heat conduction from the valve's environment, such as within the engine's exhaust stream, which heat load can adversely affect the solenoid's performance.

Yet another problem in using full-stroke actuation of known solenoid valves is audible noise or clatter emanating from the valve and attached solenoid. The valve can emit a sharp sound at various points in its cycle, such as when the head strikes the seat, and when the pintle and solenoid armature strike the valve or solenoid housing at either end of the solenoid's stroke. The sound signature is commonly audible, typically at 20 Hz or greater, and at certain engine conditions it can be objectionable to a consumer, especially at engine idle. In many applications, it is necessary to resort to sound suppressive measures such as absorptive mountings and/or insulative coverings, which can be costly, consumptive of precious space in a vehicle, and only partially effective.

Yet another problem is accelerated wear of moving components in such solenoid-actuated valves resulting from high impact loads and thermally-induced misalignments.

What is needed is an improved solenoid-actuated short-stroke valve assembly wherein the configuration of valve and solenoid components and selection of materials minimizes the mechanical noise of operation radiated from the valve assembly; reduces the mechanical loads imposed on various components; results in a significant reduction in weight and/or overall size of the valve assembly; results in a higher-force or smaller solenoid actuator; includes a resilient seal means to withstand operating temperature extremes; includes a metal-mesh shaft seal; and permits reduced operating temperatures through more efficient heat dissipation.

### SUMMARY OF THE INVENTION

Briefly described, a short-stroke solenoid-actuated valve in accordance with the invention includes:

a) a plurality of components, including solenoid polepieces, formed of powdered metal, preferably a 400-series stainless steel compressed to about 6.0 g/cm³, to be sound absorptive and ferromagnetic;

b) resilient radial seal means disposed in a full-fitting annular groove in an outer surface of the valve for sealing against a cylindrical receiving surface;

c) a shaft seal means disposed around the pintle shaft for inhibiting the leakage of gas from the valve into the actuator; and

d) a dielectric polymeric encapsulant loaded with a particulate substance to increase the heat-transfer modulus of the encapsulation.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is an elevational cross-sectional view of a prior art short-stroke solenoid-actuated valve for modulated pulsewidth control of flow;

FIG. 2 is an elevational cross-sectional view of a short-stroke solenoid-actuated valve in accordance with the invention;

FIG. 3 is a plan view of a seal ring in accordance with the invention;

FIG. 4 is an elevational view, partially in cross-section, of the seal ring shown in FIG. 3; and

FIGS. 4a through 4d are detailed views, taken at circle 4 in FIG. 4, of alternative structures for sealably closing the ring shown in FIGS. 3 and 4, structure 4d being the currently preferred embodiment.

### DESCRIPTION OF THE PREFERRED EMBODIMENTS

Benefits and advantages of a short-stroke solenoid-actuated valve in accordance with the invention may be better appreciated by first considering a prior art valve.

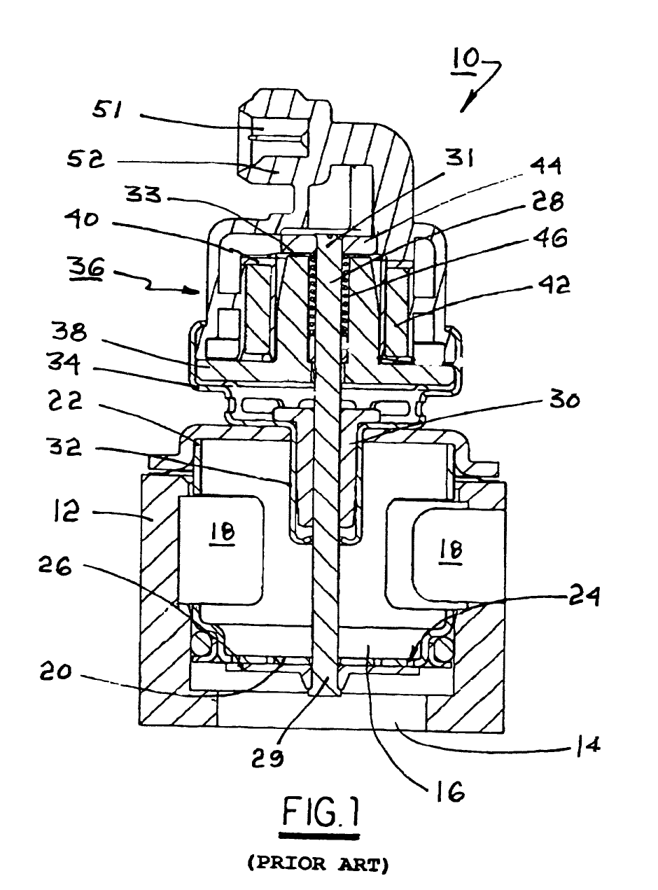

Referring to FIG. 1, a prior art short-stroke solenoid-actuated valve assembly 10 includes a valve body 12 having a first port 14 separated from an internal chamber 16 and associated flow passage 18 by a valve seat 20 formed integrally with a valve base 22 insertable into body 12. Seat 20 is typically a perforated plate having orifices 24 which are covered and uncovered to vary flow therethrough by a valve plate 26 attached to and actuated axially by a valve pintle shaft 28 at a distal end 29 thereof. Shaft 28 is disposed in an axial bore in shaft bushing 30 which is supported in a well 32 formed in actuator housing 34.

Actuator assembly 36 includes housing 34, primary pole piece 38, secondary pole piece 40, electric coil 42, armature 44, shaft return spring 46, connector 51, and encapsulating shroud 52. The pole pieces typically are formed of iron or steel, and the valve body, base, seat, plate, and shaft are formed of steel or other materials suitable to the end use of the valve.

Armature 44 is connected to the proximal end 31 of shaft 28 such that the armature, shaft, and valve plate are oscillatable axially as an integral unit by actuator assembly 36. The stroke of the valve is defined by the gap 33 between armature 44 in the valve-closed position, shown in FIG. 1, and the upper end of primary pole piece 38.

The details of construction and operation of prior art assembly 10 are substantially as disclosed in the incorporated reference.

Significant clatter occurs in the actuation of valve assembly 10. The kinetic energy contained in the integral plate, shaft, and armature is applied to the primary pole piece 38 as a stroke-limiting dead stop for valve opening, and to valve seat 20 upon closing. Actuations may occur at relatively high frequency, typically, 20 Hz, since the objective of on-off control is a time-average flow. Several of the components of the prior art assembly are highly conducive of sound and may also be prone to ringing, which can add significantly to an undesirable actuation noise level.

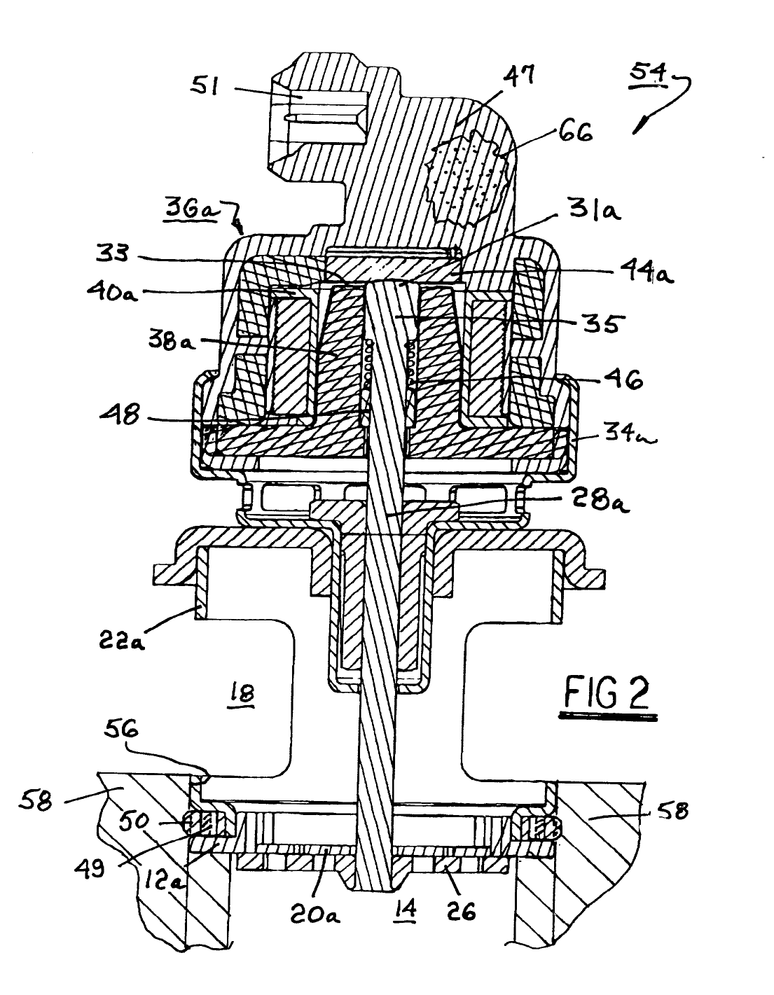

Referring to FIG. 2, an improved short-stroke solenoid-actuated valve assembly 54 is formed in most respects similar to prior art assembly 10. However, significant reduction in mechanical clatter and improvement in assembly performance are achieved through the following novel changes and additions: a plurality of assembly components formed of acoustic damping powdered metal; resilient radial seal means for sealing the valve assembly to a cylindrical application surface; metal mesh shaft seal for inhibiting gas leakage into the actuator; and high heat-transfer polymer for encapsulating the solenoid.

Improved valve seat 20a preferably is formed separately from valve base 22a and is disposed in valve body 12a. Alternatively, seat 20a and base 22a can be provided as an integral unit as in the prior art. Seat 20a is formed of a suitable acoustically dead material, preferably compressed powdered metal. The forming of metal parts by compressing powdered metals is well known in the forming arts. Preferably, an integral base/seat unit similar to the prior art unit may be formed entirely of powdered metal. Preferably, the surface of seat 20a for making contact with valve plate 26 is locally densified as by surface smearing, qualifying, coining, or other known techniques to increase its durability. Forming seat 20a from powdered metal significantly reduces the generation and transmission of sound resulting from the impact of the valve plate on the valve seat. Powdered metal is known for its acoustic deadening properties, due to the substantial void volume contained therein.

Improved primary pole piece 38a preferably is formed from powdered metal, thereby reducing clatter from impact of the armature at the end of the valve-opening stroke and reducing mass of the component and therefore mass of the assembly. Preferably, improved secondary pole piece 40a, actuator housing 34a, and various other components are also formed of powdered metal to reduce sound transmission and weight of the valve.

Improved pintle shaft 28a is provided with a flared head 35 at proximal end 31a for capturing return spring 46 which, when compressed by the valve being opened, thus acts directly upon the pintle shaft rather than upon the armature, as in prior art assembly 10, to close the valve upon de-energizing of the solenoid. Further, armature 44a is not connected to shaft 28a but acts on it only in compression. As shown in FIG. 2 in the valve-closed position, shaft end 31a extends beyond the end of primary pole piece 38a and across gap 33 to make contact with armature 44a. When the solenoid is energized to open the valve, only the kinetic energy of the armature is brought to bear on the upper end of pole piece 38a, thus reducing the impact and clatter over that produced by the prior art solenoid. The pintle shaft 28a and valve plate 26 are cast loose from the armature and are carried by their momentum through a short, predetermined distance of over-travel of the mechanically configured open position, before beginning the closing return stroke under impetus from compressed spring 46. Further, when the valve re-closes, only the kinetic energy of the pintle shaft and valve plate are brought to bear on the valve seat, thus reducing the impact over that experienced by the prior art valve.

Powdered metal used in forming the just-described components is preferably a 400-series stainless steel, most preferably 410L. These materials are ferromagnetic and saturate at lower flux levels than iron and can increase the actuation force of the solenoid from, typically, about 15 N in prior art solenoids to about 75 M in same-size solenoids formed in accordance with the present invention, thus permitting if desired a substantial reduction in size of the solenoid. In addition, prior art iron pole pieces typically have a density of about 7.8 g/cm³, whereas the present pole pieces preferably have a density of about 6.0 g/cm³, thus affording a significant reduction in overall weight of the valve assembly. Preferably, further weight reductions are provided by forming other assembly components from powdered metal as described above.

A tight tolerance pintle shaft seal 48 is preferably included to limit the actuator from being exposed to exhaust gas condensates. The seal is formed of a material capable of withstanding high temperatures and has tight tolerances to the pintle shaft, and is preferably formed of a metal mesh such as stainless steel or bronze. Preferably, the seal has radial clearance within polepiece 38a to allow some float to compensate for stack up of co-location misalignments. It is held in position by an axial force generated by return spring 46. The seal also functions as a spring support, and the length of the seal then sets the compressive preload on the spring. Preferably, the forces involved in the collapse and extension of spring 46 in operation are matched to the moving mass of the pintle shaft and valve head in such a way, as will be obvious to one of ordinary skill in the art, that a slight angular rotation, preferably about ½ degree, is imparted to the pintle shaft with each stroke event thereof, thereby rotating the valve plate 26 relative to the valve seat 20a. This motion constantly refreshes the interface therebetween, preventing accumulation of patterns of exhaust debris and enhancing durability of the valve.

Improved actuator assembly 36a includes an overmolded encapsulant 47 formed of a thermally conductive, heat-resistant dielectric polymer, for example, nylon. Other suitable polymers as may occur to one of ordinary skill in the art of polymers are within the spirit and scope of the invention. The inherent thermal conductivity of the polymer is augmented by loading the polymer with particulate substances 66 having inherently higher heat transfer modulus than the polymer, for example, finely divided graphite, ceramics, or the like.

Improved valve assembly 54 further includes an annular groove 49 formed in an outer surface of the assembly between flow passage 18 and first port 14 for receiving a compressible seal ring 50. Ring 50 is close-fitting to the axial-face sides of the groove and is resiliently compressed into the groove when assembly 54 is inserted into a close-fitting mating bore 56 in engine manifold 58, as shown in FIG. 2.

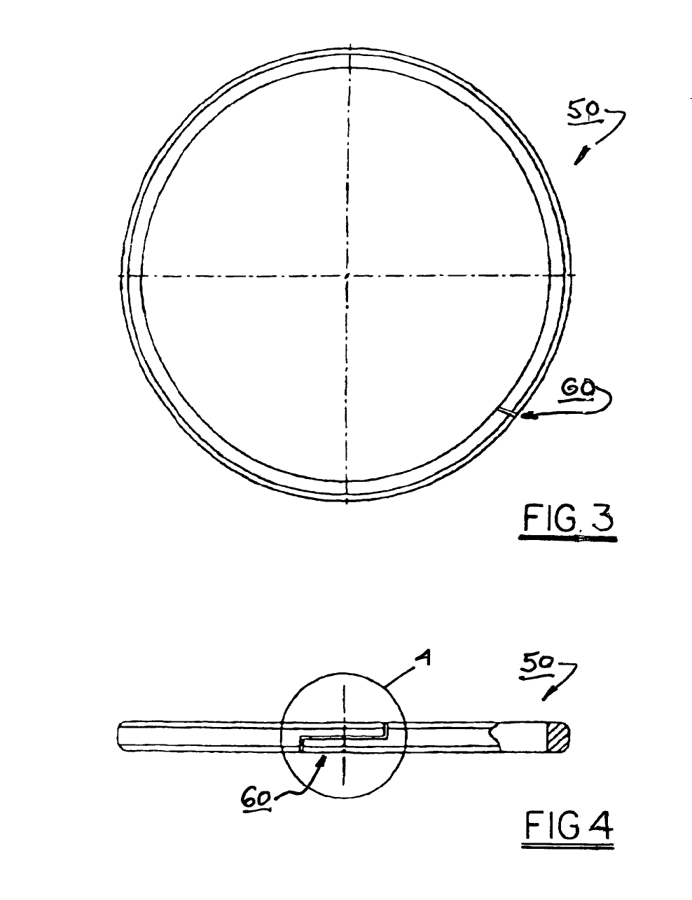

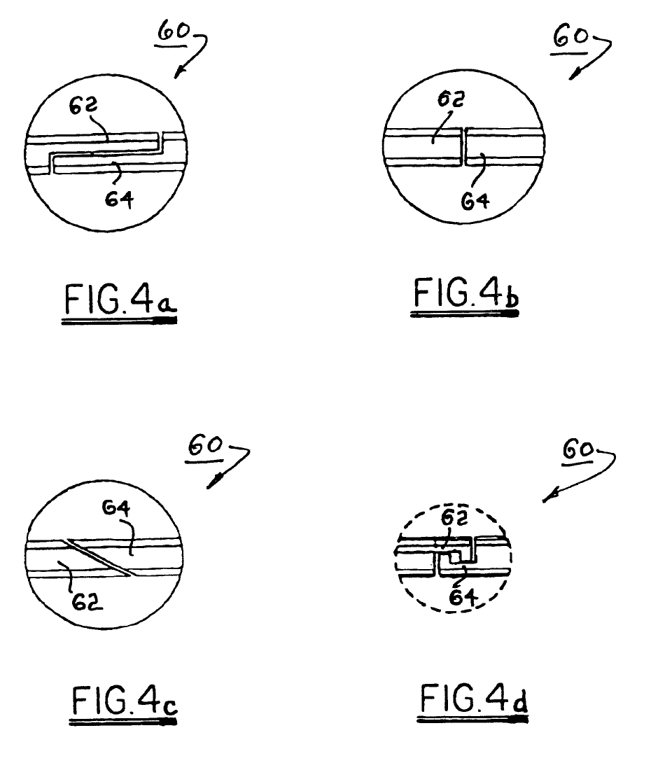

Referring to FIGS. 3 through 4d, ring 50 preferably is not a solid ring but rather employs a split 60 which permits the ring to be diametrically compressed by insertion into bore 56. Because in insertion and subsequent valve operation the ring is resiliently compressed, similar to a piston ring in an engine cylinder, the gas seal between chambers 14 and 18 is maintained independent of thermal conditions or thermal dimensional change in the valve assembly or the engine manifold.

Examples of configurations of ring 50 in a non-compressed state in accordance with the invention are shown in FIGS. 4a through 4d. The intent is to minimize and preferably to eliminate split 60 by compression of the ring during insertion. In FIG. 4a, left limb 62 overlaps right limb 64 in an offset overlap. In FIG. 4b, left limb 62 abuts right limb 64. In FIG. 4c, right limb 64 diagonally overlaps left limb 62. In FIG. 4d, the currently preferred embodiment, left limb 62 overlaps right limb 64 as in FIG. 4a and also interlocks therewith to maintain a seal through split 60 under varying degrees of compression of the ring 50.

It will be apparent to one of ordinary skill in the art that an improved short-stroke valve assembly for pulsewidth modulated flow control, as illustrated and described herein, and many of its features, could take various forms as applied to other applications and the like. While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A solenoid-actuated poppet valve assembly comprising components including a pintle shaft, a first pole piece of a solenoid actuator, a second polepiece of a solenoid actuator, an armature of a solenoid actuator, a housing of a solenoid actuator, a valve body, a valve seat, and a valve plate,
wherein at least one of said components is formed of powdered metal.

2. A valve assembly in accordance with claim 1 wherein all of said components are formed of powdered metal.

3. A valve assembly in accordance with claim 1 wherein said powdered metal is a 400-series stainless steel.

4. A valve assembly in accordance with claim 1 further comprising:
a) an annular groove formed in an outer surface of said assembly; and
b) a seal ring disposed in said groove for forming a radial seal in a cylindrical bore.

5. A valve assembly in accordance with claim 4 wherein said seal ring is discontinuous and includes a gap.

6. A valve assembly in accordance with claim 5 wherein said gap is formed between first and second limbs of said seal ring.

7. A valve assembly in accordance with claim 6 wherein said first and second limbs are circumferentially overlapped.

8. A valve assembly in accordance with claim 1 further comprising an encapsulant surrounding said actuator, said encapsulant being formed of a thermally conductive polymer.

9. A valve assembly in accordance with claim 8 wherein said polymer is nylon.

10. A valve assembly in accordance with claim 8 wherein said encapsulant includes a thermally conductive particulate material dispersed in said polymer.

11. A valve assembly in accordance with claim 10 wherein said thermally conductive particulate material is selected from the group consisting of graphite and ceramics.

12. A valve assembly in accordance with claim 1 further comprising an annular seal disposed around said pintle shaft seal for inhibiting leakage from said valve body into said solenoid actuator, said seal being formed of a metal mesh.

13. A valve assembly in accordance with claim 12 wherein said metal is selected from the group consisting of stainless steel and bronze.

14. A solenoid-actuated poppet valve assembly, comprising:
a) a valve plate, a valve seat, and a first pole piece of an actuator, said plate, seat, and pole piece being formed of powdered metal;
b) a seal ring disposed in an annular groove in said assembly for forming a radial seal in a cylindrical bore;
c) a metal mesh shaft seal disposed around said valve poppet for inhibiting leakage from said valve into said actuator; and
d) an encapsulant surrounding said actuator and being formed of a thermally conductive polymer.

15. An internal combustion engine, comprising:
a) an exhaust manifold;
b) an intake manifold; and
c) an exhaust gas recirculation (EGR) valve assembly connected between said exhaust manifold and said intake manifold for controllably recirculating exhaust gas into said intake manifold, said EGR valve assembly including
a valve plate, a valve seat, and a first pole piece of an actuator, said plate, seat, and pole piece being formed of powdered metal,
a seal ring disposed in an annular groove in said assembly for forming a radial seal in a cylindrical bore,
a metal mesh shaft seal disposed around said valve poppet for inhibiting leakage from said valve into said actuator; and
an encapsulant surrounding said actuator and being formed of a thermally conductive polymer.
